(19) United States
(12) Patent Application Publication
(10) Pub. No.: US 2015/0247046 A1
(43) Pub. Date: Sep. 3, 2015

(54) NON-AQUEOUS INK JET INK COMPOSITION AND INK JET RECORDING METHOD USING SAME

(71) Applicant: Seiko Epson Corporation, Tokyo (JP)

(72) Inventors: Kenichi Numakura, Azumino-shi (JP); Akihito Sao, Matsumoto-shi (JP); Makoto Nagase, Shiojiri-shi (JP); Kenichiro Kubota, Matsumoto-shi (JP)

(73) Assignee: Seiko Epson Corporation, Tokyo (JP)

(21) Appl. No.: 14/636,660

(22) Filed: Mar. 3, 2015

(30) Foreign Application Priority Data
Mar. 3, 2014 (JP) 2014-040642

(51) Int. Cl. C09D 11/322; C09D 11/107; C09D 11/36

(52) U.S. Cl. CPC C09D 11/322; C09D 11/36; C09D 11/107

(57) ABSTRACT

A non-aqueous ink jet ink composition according to the invention contains a coloring material; a glycol ether-based solvent; and 10% by mass to 40% by mass of a carbonate-based solvent. It is preferable that the carbonate-based solvent is a compound represented by the general formula (2).

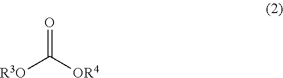

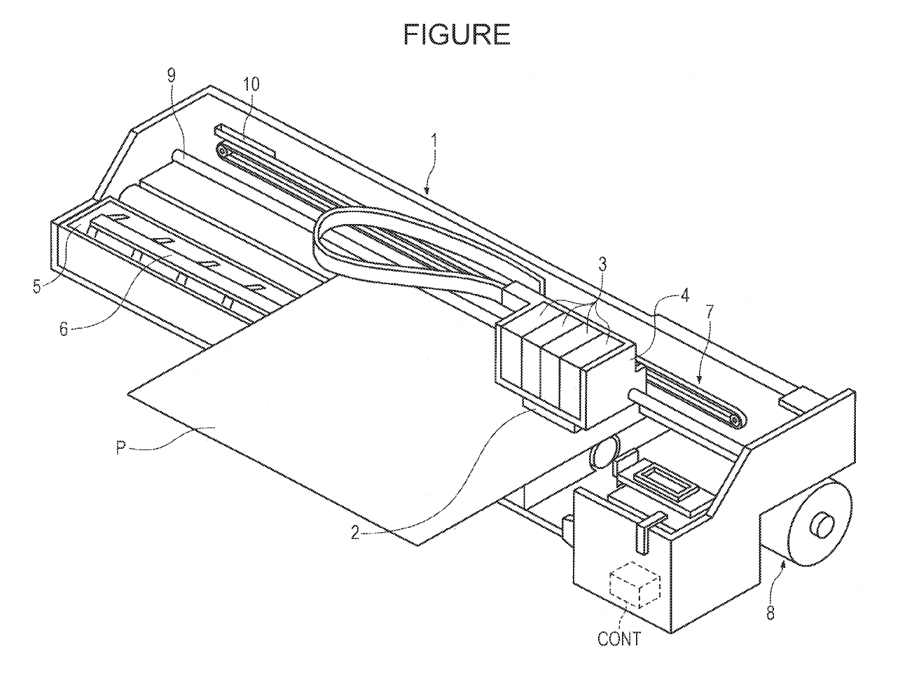

(In the general formula (2), R³ and R⁴ each independently represent a hydrocarbon group which may be substituted and has 1 to 4 carbon atoms.)

### BACKGROUND

1. Technical Field

The present invention relates to a non-aqueous ink jet ink composition and an ink jet recording method using the same.

2. Related Art

In the related art, an ink jet recording device that ejects fine droplets of an ink from a nozzle of a recording head to be adhered to a recording medium and records an image or a character is known. As an ink composition used for recording, a water-based (aqueous) ink composition obtained by dispersing or dissolving a pigment or a resin in water is known. Further, a non-aqueous (oily) ink composition that does not contain water and is obtained by dispersing or dissolving a pigment or a resin in an organic solvent has been developed.

JP-A-2012-107174 describes that it is possible to prevent strike-through with respect to the surface of printing paper and to realize high printing density using a non-aqueous ink composition among ink compositions for ink jet recording which contains a pigment and 50% by mass or more of a five-membered heterocyclic compound (for example, a carbonate compound) as an organic solvent.

A carbonate-based solvent described in JP-A-2012-107174 has excellent wet spreadability with respect to a recording medium such as a film and is excellent in the action of dissolving a vinyl chloride resin. Therefore, the non-aqueous ink composition containing a carbonate-based solvent can be preferably used for a recording medium having a vinyl chloride resin on the recording surface. However, the balance between permeability and wet spreadability of the non-aqueous ink composition is lost in some cases depending on the content of the carbonate-based solvent contained in the non-aqueous ink composition. In this case, unevenness is generated in an image to be recorded and glossiness of the image is decreased.

Meanwhile, depending on the kind of organic solvent to be used for the non-aqueous ink composition, a problem of an odor is generated and handling of the organic solvent becomes difficult because of high viscosity in some cases.

### SUMMARY

An advantage of some aspects of the invention is to provide a non-aqueous ink jet ink composition which can record an image with excellent glossiness and has a low odor and low viscosity and a recording method using the same.

The invention can be realized in the following forms or application examples.

### Application Example 1

According to Application Example 1, there is provided a non-aqueous ink jet ink composition containing: a coloring material; a glycol ether-based solvent; and 10% by mass to 40% by mass of a carbonate-based solvent.

### Application Example 2

In the non-aqueous ink jet ink composition according to Application Example 1, the carbonate-based solvent may be a compound represented by the general formula (2).

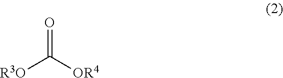

(In the general formula (2), R³ and R⁴ each independently represent a hydrocarbon group which may be substituted and has 1 to 4 carbon atoms).

### Application Example 3

In the non-aqueous ink jet ink composition according to Application Example 1 or 2, the carbonate-based solvent may be at least one kind selected from dimethyl carbonate, ethyl methyl carbonate, and diethyl carbonate.

### Application Example 4

In the non-aqueous ink jet ink composition according to any one of Application Examples 1 to 3, the viscosity of the carbonate-based solvent at 20° C. may be in a range of 0.3 mPa·S to 5 mPa·s.

### Application Example 5

In the non-aqueous ink jet ink composition according to any one of Application Examples 1 to 4, the content of the glycol ether-based solvent may be in a range of 20% by mass to 80% by mass.

### Application Example 6

In the non-aqueous ink jet ink composition according to any one of Application Examples 1 to 5, the non-aqueous ink jet ink composition may further contain at least one of a resin and a surfactant.

### Application Example 7

In the non-aqueous ink jet ink composition according to Application Example 6, the resin may include at least one of a polyester resin, a (meth)acrylic resin, and a vinyl chloride resin.

### Application Example 8

In the non-aqueous ink jet ink composition according to any one of Application Examples 1 to 7, the viscosity of the non-aqueous ink composition at 20° C. may be in a range of 2 mPa·s to 15 mPa·s.

### Application Example 9

In the non-aqueous ink jet ink composition according to any one of Application Examples 1 to 8, the surface tension of the non-aqueous ink composition at 25° C. may be in a range of 10 mN/m to 40 mN/m.

### Application Example 10

In the non-aqueous ink jet ink composition according to any one of Application Examples 1 to 9, the non-aqueous ink jet ink composition may be used for recording with respect to a recording medium having a recording surface that contains a vinyl chloride resin.

### Application Example 11

According to Application Example 11, there is provided an ink jet recording method including: ejecting droplets of the non-aqueous ink jet ink composition according to any one of Application Examples 1 to 10 from a recording head and adhering the droplets to a recording medium.

### BRIEF DESCRIPTION OF THE DRAWINGS

The invention will be described with reference to the accompanying drawings, wherein like numbers reference like elements.

FIGURE is a perspective view schematically illustrating a configuration of an ink jet printer which can be used in the present embodiment.

### DESCRIPTION OF EXEMPLARY EMBODIMENTS

Hereinafter, embodiments of the invention will be described. The embodiments described below describe examples of the invention. The invention is not limited to the following embodiments and includes various modifications in the range not departing from the scope of the invention. Further, it cannot be said that all configurations described below are essential configurations of the invention.

The term “non-aqueous ink composition” of the invention is an ink which uses an organic solvent as a main solvent and does not use water as a main solvent. The content of water in an ink is preferably 3% by mass or less, more preferably 1% or less, still more preferably less than 0.05% by mass, still more preferably less than 0.01% by mass, still more preferably less than 0.005% by mass, and most preferably less than 0.001% by mass. Alternatively, the non-aqueous ink composition may be an ink which does not substantially contain water. The expression “does not substantially contain water” means that water is not allowed to be intentionally contained.

### 1. Non-Aqueous Ink Composition for Ink Jet Recording

A non-aqueous ink composition for ink jet recording (hereinafter, also referred to as “non-aqueous ink jet ink composition”) according to an embodiment of the invention is an ink composition used for an ink jet recording method and contains a coloring material, a glycol ether-based solvent, and 10% by mass to 40% by mass of a carbonate-based solvent. Hereinafter, components contained in the non-aqueous ink composition according to the present embodiment will be described in detail.

### 1.1. Coloring Material

As the coloring material, a dye may be used or a pigment such as an inorganic pigment or an organic pigment may be used, but it is preferable to use a pigment from the viewpoint of light resistance or the like. These coloring materials may be used alone or in combination of two or more kinds thereof.

Examples of the organic pigment include an azo pigment (such as azo lake, an insoluble azo pigment, a condensed azo pigment, or a chelate azo pigment); a polycyclic pigment (such as a phthalocyanine pigment, perylene, a perylene pigment, an anthraquinone pigment, a quinacridone pigment, a dioxazine pigment, a thioindigo pigment, an isoindolinone pigment, or a quinophthalone pigment); a lake dye (such as a basic dye type lake or an acidic dye type lake); a nitro pigment, a nitroso pigment, aniline black, and a daylight fluorescent pigment. Further, examples of the inorganic pigment include carbon black, titanium dioxide, silica, and alumina.

The content of the coloring material can be appropriately set according to the necessity and is not particularly limited, but the content thereof is generally in the range of 0.1% by mass to 10% by mass with respect to the total mass (100% by mass) of the non-aqueous ink composition.

Moreover, in a case where a pigment is used as a coloring material, a pigment dispersant may be contained and examples thereof include a polyester polymer compound such as Hinoact KF1-M, T-6000, T-7000, T-8000, T-8350P, or T-8000E (all manufactured by Takeo Fine Chemical Co., Ltd.); Solsperse 20000, 24000, 32000, 32500, 33500, 34000, 35200, 37500, and 39000 (all manufactured by LUBRIZOL, Inc.); Disperbyk-161, 162, 163, 164, 166, 180, 190, 191, 192, 2091, and 2095 (all manufactured BYK Japan K.K.); Fluorene DOPA-17, 22, 33, and G-700 (all manufactured by KYOEISHA Chemical Co., Ltd.); AJISPER PB821 and PB711 (both manufactured by Ajinomoto Co., Inc.); and LP4010, LP4050, LP4055, POLYMER 400, 401, 402, 403, 450, 451, and 453 (all manufactured by EFKA Chemicals, Inc.). In the case where a pigment dispersant is used, the content thereof can be appropriately selected according to the pigment to be contained, but is preferably in the range of 5 parts by mass to 200 parts by mass and more preferably in the range of 30 parts by mass to 120 parts by mass with respect to 100 parts by mass of the content of the pigment in the non-aqueous ink composition.

### 1.2. Glycol Ether-Based Solvent

The glycol ether-based solvent has moderate resin solubility even though the boiling point thereof is high and viscosity suitable for an ink jet ink and can suppress unevenness of an image to be recorded by controlling wettability or the infiltration rate with respect to a recording medium. Further, the glycol ether-based solvent has a low odor.

Examples of the glycol ether-based solvent include alkylene glycol monoether and alkylene glycol diether. The glycol ether-based solvent can be used alone or in combination of two or more kinds thereof.

Examples of the alkylene glycol monoether include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, dipropylene glycol monomethyl ether, and dipropylene glycol monoethyl ether.

Examples of the alkylene glycol diether include ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, diethylene glycol butyl methyl ether, triethylene glycol dimethyl ether, triethylene glycol diethyl ether, triethylene glycol dibutyl ether, triethylene glycol butyl methyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

It is preferable to use diethylene glycol ethyl methyl ether or diethylene glycol diethyl ether among the above-described glycol ether-based solvents in terms of further reducing an odor.

The content of the glycol ether-based solvent is preferably in the range of 20% by mass to 80% by mass, more preferably in the range of 30% by mass to 70% by mass, and still more preferably in the range of 35% by mass to 65% by mass with respect to the total mass of the non-aqueous ink composition. When the content of the glycol ether-based solvent is 20% by mass or more, it is possible to further suppress generation of an odor of the non-aqueous ink composition or an image to be recorded using the non-aqueous ink composition or to further decrease generation of printing unevenness. In addition, when the content of the glycol ether-based solvent is 80% by mass or less, it is possible to suppress a decrease of glossiness of an image.

From a viewpoint of ease of setting the viscosity of the non-aqueous ink composition to be in an appropriate range as an ink for ink jet recording or improving wet spreadability of an ink, a solvent with low viscosity among the glycol ether-based solvents is preferably used. Specifically, the viscosity of the glycol ether-based solvent at a temperature of 20° C. is in the range of 0.5 mPa·s to 10 mPa·s and more preferably in the range of 0.5 mPa·s to 5 mPa·s. Further, the viscosity thereof can be measured by increasing the shear rate to be in the range of 10 to 1000 in an environment of 20° C. and reading the viscosity at the time when the shear rate is 200 using a viscoelasticity testing machine MCR-300 (manufactured by Physica, Inc.).

### 1.3. Carbonate-Based Solvent

The carbonate-based solvent can improve adhesiveness of the non-aqueous ink composition with respect to a recording medium by dissolving a part of a recording surface (preferably a recording surface including a vinyl chloride resin) and infiltrating the non-aqueous ink composition into the recording medium. In addition, since the carbonate-based solvent has excellent wet spreadability on the recording surface (preferably a recording surface including a vinyl chloride resin), the flatness of an image can be improved so that the glossiness of an image becomes excellent. Moreover, since the carbonate-based solvent has a low odor, generation of an odor can be effectively decreased by using the carbonate-based solvent and the above-described glycol ether-based solvent together. Further, by using the carbonate-based solvent and the glycol ether-based solvent together, the viscosity of the non-aqueous ink composition can be easily adjusted to be low and the solubility of a resin included in the non-aqueous ink composition can be improved.

The carbonate-based solvent of the invention means a compound including a carbonate skeleton and, for example, a compound represented by the following general formula (1) can be used.

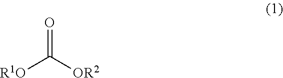

In the general formula (1), R¹ and R² each independently represent a hydrocarbon group which may be substituted and R¹ and R² may form a ring by being bonded to each other. Examples of the substituent of the hydrocarbon group include a hydroxyl group and a carboxyl group. The hydrocarbon group can be linear or branched and the hydrocarbon group having 1 to 15 carbon atoms can be preferably used.

Specific examples of the compound represented by the general formula (1) include a carbonate compound having a non-cyclic structure such as dimethyl carbonate, ethyl methyl carbonate, diethyl carbonate, dipropyl carbonate, or dibutyl carbonate; and a carbonate compound having a cyclic structure such as ethylene carbonate, propylene carbonate, 1,2-butylene carbonate, 2,3-butylene carbonate, or glycerol carbonate.

A compound represented by the following general formula (2) among the compounds represented by the general formula (1) is preferably used.

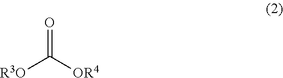

In the general formula (2), R³ and R⁴ each independently represent a hydrocarbon group which may be substituted and has 1 to 4 carbon atoms. The hydrocarbon group having 1 to 4 carbon atoms can be linear or branched, and examples thereof include a methyl group, an ethyl group, an n-propyl group, an iso-propyl group, an n-butyl group, a sec-butyl group, an iso-butyl group, and a tert-butyl group. Examples of the substituent of the hydrocarbon group having 1 to 4 carbon atoms include a hydroxyl group and a carboxyl group.

The compound represented by the general formula (2) is a carbonate compound having a non-cyclic structure and the number of carbon atoms of R³ and R⁴ described above is small. Accordingly, since the compound has low viscosity, the compound is preferably used in terms of improving wet spreadability of an ink and further improving glossiness of an image.

Specific examples of the compound represented by the general formula (2) include dimethyl carbonate, ethyl methyl carbonate, diethyl carbonate, dipropyl carbonate, and dibutyl carbonate. Among these, at least one kind selected from dimethyl carbonate, ethyl methyl carbonate, and diethyl carbonate is preferably used from a viewpoint of further improving glossiness of an image.

It is necessary for the content of the carbonate-based solvent to be in the range of 10% by mass to 40% by mass with respect to the total mass of the non-aqueous ink composition, but the content thereof is preferably in the range of 15% by mass to 35% by mass and more preferably in the range of 20% by mass to 30% by mass. When the content of the carbonate-based solvent is in the above-described range, the glossiness of an image to be recorded becomes excellent. Particularly, when a recording medium having a recording surface of the vinyl chloride resin is used, since the balance between the permeability of the non-aqueous ink composition and the wet spreadability becomes excellent, improvement of glossiness, a decrease in stripe unevenness, securing a line width, or a decrease in printing unevenness can be achieved in a high level. Meanwhile, when the content of the carbonate-based solvent is less than 10% by mass, the wet spreadability of an ink becomes insufficient so that the glossiness of an image is decreased. In addition, the content of the carbonate-based solvent exceeds 40% by mass, the balance between the permeability and wet spreadability of an ink is lost so that the glossiness of an image is decreased or the printing unevenness is generated.

Moreover, in the present specification, the term “printing unevenness” means local density spots generated when ink droplets are adhered to a recording medium and is a phenomenon observed by the film thickness of a solid component (a resin component, a coloring material component, and the like) becoming ununiform. In addition, the term “strip unevenness” means a phenomenon in which the surface of a recording medium is not coated with ink droplets or a portion whose coating is ununiform remains in a stripe form accompanied by filling failures of ink droplets on the recording medium.

The viscosity of the carbonate-based solvent at 20° C. is preferably in the range of 0.3 mPa·s to 5 mPa·s, the lower limit thereof is more preferably 0.5 mPa·s or more, and the upper limit thereof is more preferably 4 mPa·s or less, still more preferably 3 mPa·s or less, and particularly preferably 2 mPa·s or less. In addition, the viscosity of the carbonate-based solvent can be measured by the method and the apparatus which are the same as those used for measuring the viscosity of the above-described glycol ether-based solvent. When the viscosity of the carbonate-based solvent is in the above-described range, there is an advantage in which the viscosity of the non-aqueous ink composition can be easily set to be in an appropriate range as an ink for ink jet recording or the non-aqueous ink composition becomes easily wet and spread so that the glossiness is improved.

From a viewpoint of further reducing the odor of the non-aqueous ink composition or an image to be recorded using the non-aqueous ink composition, further decreasing the viscosity thereof, or improving resin solubility, the total content of the carbonate-based solvent and the above-described glycol ether-based solvent is preferably in the range of 40% by mass to 90% by mass and more preferably in the range of 45% by mass to 85% by mass with respect to the total mass of the non-aqueous ink composition.

### 1.4. Resin

It is preferable that the non-aqueous ink composition according to the present embodiment contains a resin. Examples of the function of a resin, protecting an image obtained from the non-aqueous ink composition by forming a film. The resin is referred to as a resin for fixation in some cases.

Examples of the resin include a (meth)acrylic resin (such as a poly (meth)acrylate, polymethyl (meth)acrylate, polyethyl (meth)acrylate, a (meth)acrylic acid-(meth)acrylic acid ester copolymer resin, a styrene-(meth)acrylic copolymer resin, an ethylene-(meth)acrylic acid copolymer resin, an ethylene alkyl (meth)acrylate resin, or an ethylene-(meth)acrylic acid ester copolymer resin); a vinyl chloride resin (such as polyvinyl chloride or a vinyl chloride-vinyl acetate copolymer resin); a polyester resin (such as aliphatic polyester or aromatic polyester); polyurethane, an epoxy resin, polyvinyl acetate, an ethylene-vinyl acetate copolymer resin, polycarbonate, polyvinyl butyral, polyvinyl alcohol, a phenoxy resin, an ethyl cellulose resin, a cellulose acetate propionate resin, cellulose acetate butyrate, a nitrocellulose resin, polystyrene, a vinyl toluene-α-methyl styrene copolymer resin, polyamide, polyimide, a polysulfone resin, a petroleum resin, chlorinated polypropylene, polyolefin, a terpene resin, a rosin-modified phenol resin, various synthetic rubber such as NBR, SBR, or MBR, and a modified product thereof. These resins may be used alone or in combination of two or more kinds thereof.

It is preferable that the non-aqueous ink composition according to the present embodiment contains at least one kind selected from a polyester resin, a (meth)acrylic resin, a vinyl chloride resin among the above-described resins from a viewpoint of further improving abrasion resistance of an image.

The polyester resin is a polymer obtained by polycondensing polyol and polycarboxylic acid. A commercially available product may be used as resin emulsion containing an ester resin and examples thereof include Elitel KA-5034, KA-5071S, KZA-1734, KZA-6034, and KZA-3556 (all trade names, manufactured by Unitika Ltd.); and TP290, TP249, and TP219 (all trade names, all manufactured by Nippon Synthetic Chemical Industry Co., Ltd.).

The (meth)acrylic resin is a polymer obtained from known monomer components in the related art. Examples of such monomer components include acrylic acid esters such as methyl acrylate, ethyl acrylate, isopropyl acrylate, n-butyl acrylate, and 2-ethylhexyl acrylate; methacrylic acid esters such as methyl methacrylate, ethyl methacrylate, isopropyl methacrylate, n-butyl methacrylate, isobutyl methacrylate, tert-butyl methacrylate, cyclohexyl methacrylate, and 2-ethylhexyl methacrylate; carboxyl group-containing monomers such as acrylic acid, methacrylic acid, maleic acid, fumaric acid, itanonic acid, mono-n-butyl maleic acid, mono-n-butyl fumaric acid, and mono-n-butyl itaconic acid; hydroxyl group-containing (meth)acrylic acid esters, amide group-containing monomers, glycidyl group-containing monomers, a cyano group-containing monomer, a hydroxyl group-containing aryl compound, a tertiary amino group-containing monomer, and an alkoxysilyl group-containing monomer, and these can be used alone or in combination of two or more kinds thereof. In the invention, (meth)acrylic acid means both of acrylic acid and methacrylic acid and (meth)acrylate means both of acrylate and methacrylate.

A commercially available product may be used as the above-described (meth)acrylic acid resin, and examples thereof include ACRYPET MF (trade name, manufactured by Mitsubishi Rayon Co., Ltd., acrylic resin); SUMIPEX LG (trade name, manufactured by Sumitomo Chemical Co., Ltd., acrylic resin); PARALOID B series (trade name, manufactured by Rohm and Haas Company, acrylic acid), and PARAPET G-1000P (trade name, manufactured by Kuraray Co., Ltd., acrylic resin).

The vinyl chloride resin contains at least vinyl chloride as a monomer component used at the time of synthesis of a resin, and a copolymer of vinyl chloride and another monomer (for example, vinyl acetate, vinylidene chloride, acryl, maleic acid, or vinyl alcohol) can be used as the vinyl chloride resin. Among these, a vinyl chloride-vinyl acetate copolymer obtained by copolymerizing vinyl chloride and vinyl acetate is preferably used.

A commercially available product may be used as the above-described vinyl chloride resin, and examples thereof include Kanevinyl HM515 and S-400 (both trade names, manufactured by Kaneka Corporation); and SOLBIN C and C5R (both trade names, manufactured by Nissin Chemical Co., Ltd.).

As the resin, any type of resin such as a solid type resin, a solution type resin, or an emulsion type resin may be used.

The content in a case of containing a resin can be set to be in the range of 0.5% by mass to 10% by mass in terms of a solid content with respect to the total mass of the non-aqueous ink composition. When the content of the resin is in the above-described range, abrasion resistance of an image becomes excellent or the viscosity of an ink can be easily set to be in the range suitable for ink jet recording.

### 1.5. Surfactant

It is preferable that the non-aqueous ink composition according to the present embodiment contains a surfactant from a viewpoint of decreasing the surface tension so that the wet spreadability on a recording medium is improved. Examples of the surfactant include a silicon-based surfactant, a fluorine-based surfactant, and a polyoxyethylene derivative which is a non-ionic surfactant.

As the silicon-based surfactant, polyester-modified silicon or polyether-modified silicon is preferably used. Specific examples thereof include BYK-347, 348, BYK-UV 3500, 3510, 3530, and 3570 (all manufactured by BYK Japan K.K.).

A commercially available product can be used as the fluorine-based surfactant and examples thereof include BYK-340 (manufactured by BYK Japan K.K.); SURFLON S-211, S-131, S-132, S-141, S-144, and S-145 (manufactured by Asahi Glass Co., Ltd.); FTERGENT 100, 150, and 251 (manufactured by Neos Company Limited); MEGAFAX F477 (manufactured by DIC Corporation); FC-170C, FE-430, and FLUORAD FC4430 (manufactured by Sumitomo 3M Ltd.); FSO, FSO-100, FSN, FSN-100, and FS-300 (manufactured by Dupont, Inc.); and FT-250 and 251 (manufactured by Neos Company Limited).

As the polyoxyethylene derivative, an acetylene glycol-based surfactant is preferably used. Specific examples thereof include SURFINOL 82, 104, 465, 485, and TG (all manufactured by Air Products Japan, Inc.); OLFIN STG and E1010 (both manufactured by Nissin Chemical Co., Ltd.); FLOWLEN TG-740W and D-90 (manufactured by KYOEISHA CHEMICAL Co., Ltd.); and NOIGEN CX-100 (manufactured by Dai-ichi Kogyo Seiyaku Co., Ltd.).

The content of a case where a surfactant is contained can be set to be in the range of 0.1% by mass to 5% by mass with respect to the total mass of the non-aqueous ink composition.

### 1.6. Other Organic Solvents

The non-aqueous ink composition according to the present embodiment may contain other organic solvents (that is, a solvent other than the glycol ether-based solvent and the carbonate-based solvent). Examples of such an organic solvent include lactone and a pyrrolidone derivative.

Lactone can improve the adhesiveness of the non-aqueous ink composition with respect to a recording medium by dissolving a part of the recording surface (preferably a recording surface including a vinyl chloride resin) and infiltrating the non-aqueous ink composition into the recording medium. The term “lactone” in the invention is a general term for cyclic compounds having an ester group (—CO—O—) in a ring. The lactone is not particularly limited as long as not departing from the above-described definition, but lactone having 2 to 9 carbon atoms is preferable. Specific examples of the lactone include α-ethyl lactone, α-acetolactone, β-propiolactone, γ-butyrolactone, δ-valerolactone, ε-caprolactone, ζ-enantiolactone, η-caprolactone, γ-valerolactone, γ-heptalactone, γ-nonalactone, β-methyl-δ-valerolactone, 2-butyl-2-ethyl propiolactone, and α,α-diethyl propiolactone, and, among these, γ-butyrolactone is particularly preferable. The above-described lactones may be used alone or in combination of two or more kinds thereof.

The content in a case of containing lactone is preferably in the range of 10% by mass to 40% by mass and more preferably in the range of 15% by mass to 30% by mass with respect to the total mass of the non-aqueous ink composition. The abrasion resistance of an image tends to be further excellent when the content of lactone is 10% by mass or more and the glossiness of an image tends to be increased when the content thereof is 40% by mass or less.

The pyrrolidone derivative is excellent in solubility of a vinyl chloride resin. Examples of the pyrrolidone derivative include N-methyl-2-pyrrolidone, N-ethyl-2-pyrrolidone, N-vinyl-2-pyrrolidone, 2-pyrrolidone, and 5-methyl-2-pyrrolidone. The pyrrolidone derivatives may be used alone or in combination of two or more kinds thereof.

### 1.7. Other Components

The non-aqueous ink composition according to the present embodiment can contain substances, according to the necessity, for imparting predetermined performance such as a pH adjusting agent, a chelating agent such as ethylenediaminetetraacetic acid salt (EDTA), a preservative, an antifungal agent, and an antirust agent.

### 1.8. Method of Producing Non-Aqueous Ink Composition

The non-aqueous ink according to the present embodiment can be obtained by mixing the above-described components in arbitrary procedures and removing impurities through filtration or the like according to the necessity. As the method of mixing respective components, a method of mixing components by sequentially adding materials to a container having a stirrer such as a mechanical stirrer or a magnetic stirrer and stirring the mixture is preferably used. As the filtration method, centrifugal filtration or filter filtration can be performed according to the necessity.

### 1.9. Physical Properties of Non-Aqueous Ink Composition

The surface tension of the non-aqueous ink composition according to the present embodiment at 25° C. is preferably in the range of 10 mN/m to 40 mN/m and more preferably in the range of 25 mN/m to 40 mN/m from a viewpoint of the balance between the recording quality and reliability of the ink for ink jet recording. The surface tension thereof can be measured by confirming the surface tension at the time when a platinum plate is wetted by the ink in an environment of 25° C. using an automatic surface tension meter CBVP-Z (manufactured by Kyowa Interface Science Co., Ltd.).

Further, from the viewpoint described above, the viscosity of the non-aqueous ink composition at 20° C. is preferably in the range of 2 mPa·s to 15 mPa·s, more preferably in the range of 2 mPa·s to 5 mPa·s, and still more preferably in the range of 2 mPa·s to 4 mPa·s. Further, the viscosity thereof can be measured by increasing the shear rate to be in the range of 10 to 1000 in an environment of 20° C. and reading the viscosity at the time when the shear rate is 200 using a viscoelasticity testing machine MCR-300 (manufactured by Physica, Inc.).

### 2. Recording Method

The ink jet recording method according to the present embodiment of the invention includes a process of ejecting droplets of the non-aqueous ink composition from a recording head and adhering the droplets to a recording medium (hereinafter, referred to as a “process (a)”). In this manner, a recording material in which an image is formed on a recorded medium can be obtained.

According to the ink jet recording method according to the present embodiment, since the above-described non-aqueous ink composition is used, it is possible to record an image which has excellent ejecting stability because of low viscosity, the low odor, and excellent glossiness.

In the ink jet recording method according to the present embodiment, the process (a) may be performed with respect to a recording medium heated in a temperature of 30° C. to 60° C. The drying properties of the ink can be improved by adhering the above-described ink composition to the recording medium heated in this manner.

Further, the ink jet recording method according to the present embodiment may include a process of further performing post-heating (after heating) on the recording medium (hereinafter, referred to as a “process (b)”) after the process (a). The drying properties of the ink can be further improved by further including the process (b).

As an ink jet recording device capable of including the above-described process, any apparatus that ejects the above-described ink composition as droplets from a fine nozzle of a recording head and adheres the droplets to a recording medium can be used. Hereinafter, as an ink jet recording device which can be used in the present embodiment, an ink jet printer having a mechanism of heating a recording medium will be described as an example.

FIGURE is a perspective view illustrating a configuration of an ink jet printer which can be used in the present embodiment (hereinafter, simply referred to as a “printer”). A printer 1 illustrated in FIGURE is referred to as a so-called serial printer. The serial printer indicates a printer in which a recording head is mounted on a carriage that moves in a predetermined direction and which ejects droplets onto a recording medium through the movement of the recording head accompanied by the movement of the carriage.

As illustrated in FIGURE, the printer 1 includes a carriage 4 which mounts a recording head 2 and to which an ink cartridge 3 is detachably installed; a platen 5 which is disposed on the lower side of the recording head 2 and to which a recording medium P is transported; a heating mechanism 6 which heats the recording medium; a carriage movement mechanism 7 that moves the carriage 4 to the recording width direction of the recording medium P; and a medium transfer mechanism 8 which transports the recording medium P to the recording transfer direction. Moreover, the printer 1 includes a control device CONT that controls the operation of the entire printer 1. In addition, the medium width direction is a main scanning direction (head scanning direction). The medium transfer direction is a sub-scanning direction (direction orthogonal to the main scanning direction).

The ink cartridge 3 is formed of four independent cartridges. The respective four cartridges are filled with the above-described non-aqueous ink composition. Further, in the example of FIGURE, the number of cartridges is four, but the number thereof is not particularly limited thereto and the desired number of cartridges can be mounted.

The ink cartridge 3 is not limited to a cartridge that is installed on the carriage 4 as illustrated in FIGURE and a cartridge that is installed on a case of the printer 1 and supplies an ink to the head 2 through an ink supply tube may be used.

The carriage 4 is attached in a state of being supported by a guide rod 9 which is a supporting member which is cross-linked in a main scanning direction. Further, the carriage 4 moves in the main scanning direction along the guide rod 9 due to the carriage movement mechanism 7. Moreover, FIGURE illustrates an example in which the carriage 4 moves in the main scanning direction, but, not limited thereto, the carriage 4 may move in the sub-scanning direction in addition to the movement in the main scanning direction.

The installation position of the heating mechanism 6 is not particularly limited as long as the heating mechanism 6 is provided in a position in which the recording medium P can be heated. In the example of FIGURE, the heating mechanism 6 is provided on the platen 5 which is a position facing the head 2. In this manner, when the heating mechanism 6 is provided in a position facing the head 2, since the position in which droplets are adhered to the recording medium P can be securely heated, the droplets adhered to the recording medium P can be efficiently dried.

As the heating mechanism 6, a print heater mechanism that brings the recording mechanism P into contact with a heat source to be heated, a mechanism that applies infrared rays or microwaves (electromagnetic waves having a maximum wavelength at approximately 2450 MHz), or a drier mechanism that blows warm air can be used.

Heating of the recording medium P using the heating mechanism 6 is performed before or after adhesion of droplets ejected from a nozzle hole (not illustrated) to the recording medium P. In this manner, the droplets adhered to the recording medium P can be rapidly dried. Further, various conditions (for example, the timing of heating, the heating temperature, and the heating time) of heating are controlled by a control device CONT.

It is preferable that the recording medium P is heated using the heating mechanism 6 such that the temperature of the recording medium P is maintained in the range of 35° C. to 50° C. from viewpoints of improving drying properties of the ink and preventing deformation of the recording medium. Further, the temperature of heating a recording medium in the invention of the present application indicates the surface temperature of the recording surface of the recording medium at the time of heating.

The printer 1 may include a second heating mechanism (not illustrated) in addition to the heating mechanism 6. The above-described process (b) can be performed using the printer 1 by the printer 1 including the second heating mechanism. The second heating mechanism is provided on the further downstream side of the recording medium P in the transporting direction in relation to the heating mechanism 6. The second heating mechanism performs heating of the recording medium P after the recording medium P is heated by the heating mechanism 6, that is, the droplets ejected from the nozzle hole (not illustrated) are adhered to the recording medium P. In this manner, the drying properties of the droplets of the ink composition adhered to the recording medium P can be further improved. Any one of mechanisms (for example, the dryer mechanism) described in the section of the heating mechanism 6 can be used for the second heating mechanism.

The heating of the recording medium P using the second heating mechanism is preferably performed such that the temperature of the recording medium P is maintained in the temperature range of 35° C. to 50° C. because of the reason which is the same as that of the heating mechanism 6.

A linear encoder 10 detects the position of the carriage 4 in the main scanning direction using a signal. The detected signal is sent to the control device CONT as positional information. The control device CONT recognizes the scanning position of the recording head 2 based on the positional information from the linear encoder 10 and controls a recording operation (ejecting operation) performed by the recording head 2. Moreover, the control device CONT has a configuration in which the movement speed of the carriage 4 can be variably controlled.

The recording medium P is not particularly limited, but the glossiness or the like of the recorded image becomes excellent even when a low-absorbing recording medium is used according to the ink jet recording method according to the present embodiment. Here, the term “low-absorbing recording medium” indicates a recording medium whose water absorption amount from the start of contact to 30 msec^{1/2} in a Bristow method is 10 mL/m² or less and at least the recording surface may include these properties. According to this definition, the “low-absorbing recording medium” of the invention includes a non-absorbing recording medium which does not absorb water at all. The Bristow method is the most common method of measuring a liquid absorption amount in a short period of time and is adopted by Japan Technical Association of the Pulp and Paper Industry (JAPAN TAPPI). Details of the test method are described in Specification No. 51 “Paper and paperboard-liquid absorbency test method-Bristow method” of “JAPAN TAPPI Paper and Pulp Test Method edited in 2000.”

Specific examples of the low-absorbing recording medium include a sheet, a film, and a textile product containing a low-absorbing material. Further, the low-absorbing recording medium may include a layer containing a low-absorbing material (hereinafter, also referred to as a “low-absorbing layer”) on the surface of a base material (for example, paper, fiber, leather, plastic, glass, ceramics, or metals). The low-absorbing material is not particularly limited and examples thereof include an olefin resin, an ester resin, a urethane resin, an acrylic resin, and a vinyl chloride resin.

Among these, as the low-absorbing recording medium, a recording medium having a recording surface containing a vinyl chloride resin can be preferably used. The above-described non-aqueous ink composition includes a carbonate-based solvent and the ink composition can be infiltrated into the recording medium by the compound dissolving the recording surface that contains a vinyl chloride resin. In this manner, the abrasion resistance of an image or a character recorded on the recording surface containing a vinyl chloride resin can be further improved. Specific examples of the vinyl chloride resin include polyvinyl chloride, a vinyl chloride-ethylene copolymer, a vinyl chloride-vinyl acetate copolymer, a vinyl chloride-vinyl ether copolymer, a vinyl chloride-vinylidene chloride copolymer, a vinyl chloride-maleic acid ester copolymer, a vinyl chloride-(meth)acrylic acid copolymer, a vinyl chloride-(meth)acrylic acid ester copolymer, and a vinyl chloride-urethane copolymer. Further, characteristics of the low-absorbing recording medium such as the thickness, the shape, the color, the softening temperature, and the hardness are not particularly limited.

### 3. Examples

Hereinafter, the invention will be further described in detail with reference to Examples and Comparative Examples, but the invention is not limited to these Examples.

### 3.1. Preparation of Non-Aqueous Ink Composition.

Only an organic solvent having an amount corresponding to the concentration listed in Table was stirred for each ink in a container to obtain a mixed solvent. Some of the obtained mixed solvent was separated, and a pigment dispersant and a pigment were added to the separated solvent in a predetermined amount and pre-dispersed in the solvent using a homogenizer, and then the resultant was subjected to a dispersion treatment using a bead mill filled with zirconia beads having a diameter of 0.3 mm, thereby obtaining a pigment dispersant. Further, a resin was added to the some of the separated mixed solvent and then stirred to obtain a resin solution in which the resin was completely dissolved. The remainder of the mixed solvent, a surfactant, and the above-described resin solution were mixed into the above-described pigment dispersant, and the mixture was stirred for 1 hour, and then the mixture was filtered using a 5 μm PTFE membrane filter, thereby obtaining a non-aqueous ink composition according to Examples and Comparative Examples.

In addition, among components used in Table, components described in trade names or abbreviations are as follows. Moreover, the viscosity of the used solvent at 20° C. is listed in Table. The viscosity of the solvent at 20° C. was measured under the conditions of a cone (diameter: 75 mm, angle: 1°) and the shear rate of 200 using a viscometer (trade name: “MCR-300,” manufactured by Physica, Inc.).

MEDG (diethylene glycol methyl ethyl ether)

SOLBIN C5R (trade name, manufactured by Nissin Chemical Co., Ltd., vinyl chloride-vinyl acetate copolymer)

PB15: 3 (C. I. Pigment Blue 15:3)

SS39000 (trade name, “Solsperse 39000,” manufactured by LUBRIZOL, Inc., pigment dispersant)

FTERGENT 251 (trade name, manufactured by Neos Company Limited, fluorine-based surfactant)

### 3.2. Evaluation Test

### 3.2.1. Evaluation of Physical Properties

### Viscosity of Non-Aqueous Ink Composition

The viscosity of each non-aqueous ink composition at 20° C. which was obtained in the above-described manner was measured. Specifically, the viscosity thereof was measured under the conditions of a cone (diameter: 75 mm, angle: 1°) and the shear rate of 200 using a viscometer (trade name: “MCR-300,” manufactured by Physica, Inc.).

Surface Tension of Non-Aqueous Ink Composition

The viscosity of each non-aqueous ink composition at 25° C. which was obtained in the above-described manner was measured. Specifically, the surface tension thereof was measured when a platinum plate was wetted by an ink in an environment of 25° C. using an automatic surface tension meter CBVP-Z (manufactured by Kyowa Interface Science Co., Ltd.) according to a Wilhelmy method.

### 3.2.2. Evaluation of Printing Quality

When each evaluation described below was performed by respectively adjusting the temperature and the humidity of an environmental test chamber to 25° C. and 65% RH with an air conditioner and a humidifier and using an ink jet printer “SC-530650” (trade name, manufactured by Seiko Epson Corporation) provided in the environmental test chamber. Moreover, the temperature and the humidity were measured by a temperature and humidity sensor provided in a case which was not affected by heat generation of an ink jet printer such as a heater. Further, the surface temperature of the recording medium at the time of recording was 25° C.

### Glossiness

A recorded material was created by performing solid printing of each non-aqueous ink composition on a glossy polyvinyl chloride sheet (type No. SV-G-1270G, manufactured by Roland DG Corporation) with 100% concentration under the conditions of an ink coating amount of 4 ng per pixel using the above-described printer and a recording resolution of 1440×1440 dpi and by drying the sheet at 25° C. and at 65% RH (relative humidity) for one day. Further, the glossiness of the solid print portion at 20° was measured using MULTI GLOSS 268 (manufactured by Konica Minolta Co., Ltd.). The evaluation criteria of the glossiness are as follows.

A: 25 or more

B: in the range of 20 to less than 25

C: in the range of 15 to less than 20

D: less than 15

### Stripe Unevenness

The presence of a white stripe extending in the main scanning direction of a head was confirmed by observing the solid print portion of the obtained recorded material visually or using a loupe (5 times) in the same manner as the evaluation of the above-described glossiness. The evaluation criteria of the stripe unevenness are as follows.

B: A white stripe was not seen even by the observation using a loupe.

C: A white stripe was not visually seen, but seen by the observation using a loupe.

D: A white stripe was visually seen.

### Line Width

A recorded material was prepared under the conditions same as those of the evaluation of the above-described glossiness except that a line extending in the main scanning direction of the head having a recording resolution of 1440 dpi×1 dpi was recorded instead of performing solid printing. The printed portion of the obtained recorded material was observed using a loupe (5 times) and the evaluation of the line width was performed according to the following evaluation criterial.

B: the contour of a line was continuously formed in a constant shape

C: the contour of a line was not in a constant shape but not disconnected.

D: a portion with disconnected line was seen.

### Printing Unevenness

The presence of printing unevenness was confirmed by observing the solid print portion of the obtained recorded material visually or using a loupe (5 times) in the same manner as the evaluation of the above-described glossiness. The evaluation criteria of the printing unevenness are as follows.

B: printing unevenness was inconspicuous in observation using a loupe

C: printing unevenness was inconspicuous in visual observation, but printing unevenness was conspicuous in observation using a loupe

D: printing unevenness was conspicuous in visual observation

### Odor

The presence of an odor was determined by smelling the solid print portion of the obtained recorded material in the same manner as that of the evaluation of the above-described glossiness.

B: there was an odor

D: there was no odor

### 3.3 Evaluation Results

The above-described evaluation results are listed in Table.

TABLE

| Composition of non-aqueous | | | Example | Example | Example | Example | Example | Example |
|---|---|---|---|---|---|---|---|---|
| ink composition | | | 1 | 2 | 3 | 4 | 5 | 6 |
| Solvent | γ-butyrolactone | | 20 | 20 | 20 | 20 | 20 | 20 |
| | (viscosity: 1.7 mPa · s) | | | | | | | |
| | MEDG | | 52 | 62 | 32 | 52 | 52 | 52 |
| | (viscosity: 1.4 mPa · s) | | | | | | | |
| | 1,4-dioxane | | 0 | 0 | 0 | 0 | 0 | 0 |
| | (viscosity: 1.3 mPa · s) | | | | | | | |
| | Dimethyl carbonate | | 20 | 10 | 40 | 0 | 0 | 0 |
| | (viscosity: 0.6 mPa · s) | | | | | | | |
| | Ethyl methyl carbonate | | 0 | 0 | 0 | 20 | 0 | 0 |
| | (viscosity: 0.7 mPa · s) | | | | | | | |
| | Diethyl carbonate | | 0 | 0 | 0 | 0 | 20 | 0 |
| | (viscosity: 0.8 mPa · s) | | | | | | | |
| | Propylene carbonate | | 0 | 0 | 0 | 0 | 0 | 20 |
| | (viscosity: 2.5 mPa · s) | | | | | | | |
| Resin for | SOLBIN C5R | | 3 | 3 | 3 | 3 | 3 | 3 |
| fixation | | | | | | | | |
| Pigment | PB15: 3 | | 3 | 3 | 3 | 3 | 3 | 3 |
| Pigment | SS39000 | | 1.5 | 1.5 | 1.5 | 1.5 | 1.5 | 1.5 |
| dispersant | | | | | | | | |
| Surfactant | FTERGENT 251 | | 0.5 | 0.5 | 0.5 | 0.5 | 0.5 | 0.5 |
| Total (% by mass) | | | 100 | 100 | 100 | 100 | 100 | 100 |
| Evaluation | Physical | Surface tension (mN/m) | 28 | 28 | 28 | 28 | 28 | 28 |
| results | properties | Viscosity (mPa · s) | 3.58 | 3.59 | 3.4 | 3.57 | 3.61 | 3.7 |
| | Printing | Glossiness | A | A | A | A | A | B |
| | quality | Stripe unevenness | B | B | B | B | B | C |
| | | Line width | B | B | B | B | B | C |
| | | Printing unevenness | B | B | B | B | B | B |
| | | Odor | B | B | B | B | B | B |

| Composition of non-aqueous | | | Comparative | Comparative | Comparative | Comparative | Comparative |
|---|---|---|---|---|---|---|---|
| ink composition | | | Example 1 | Example 2 | Example 3 | Example 4 | Example 5 |
| Solvent | γ-butyrolactone | | 20 | 20 | 20 | 20 | 20 |
| | (viscosity: 1.7 mPa · s) | | | | | | |
| | MEDG | | 72 | 67 | 27 | 17 | 0 |
| | (viscosity: 1.4 mPa · s) | | | | | | |
| | 1,4-dioxane | | 0 | 0 | 0 | 0 | 32 |
| | (viscosity: 1.3 mPa · s) | | | | | | |
| | Dimethyl carbonate | | 0 | 5 | 45 | 55 | 40 |
| | (viscosity: 0.6 mPa · s) | | | | | | |
| | Ethyl methyl carbonate | | 0 | 0 | 0 | 0 | 0 |
| | (viscosity: 0.7 mPa · s) | | | | | | |
| | Diethyl carbonate | | 0 | 0 | 0 | 0 | 0 |
| | (viscosity: 0.8 mPa · s) | | | | | | |
| | Propylene carbonate | | 0 | 0 | 0 | 0 | 0 |
| | (viscosity: 2.5 mPa · s) | | | | | | |
| Resin for | SOLBIN C5R | | 3 | 3 | 3 | 3 | 3 |
| fixation | | | | | | | |
| Pigment | PB15: 3 | | 3 | 3 | 3 | 3 | 3 |
| Pigment | SS39000 | | 1.5 | 1.5 | 1.5 | 1.5 | 1.5 |
| dispersant | | | | | | | |
| Surfactant | FTERGENT 251 | | 0.5 | 0.5 | 0.5 | 0.5 | 0.5 |
| Total (% by mass) | | | 100 | 100 | 100 | 100 | 100 |
| Evaluation | Physical | Surface tension (mN/m) | 28 | 28 | 28 | 28 | 28 |
| results | properties | Viscosity (mPa · s) | 3.62 | 3.6 | 3.39 | 3.35 | 3.61 |
| | Printing | Glossiness | D | D | C | C | B |
| | quality | Stripe unevenness | D | D | B | B | B |
| | | Line width | D | D | B | B | B |
| | | Printing unevenness | C | C | D | D | D |
| | | Odor | B | B | B | B | D |

According to the evaluation results of Table, it was shown that all of the non-aqueous ink compositions according to Examples had no odor and an image with excellent glossiness was recorded. Further, the carbonate-based solvents contained in the non-aqueous ink compositions according to Examples had low viscosities and the viscosities thereof were easily adjusted to the viscosities suitable as an ink for ink jet recording.

Meanwhile, it was shown that the glossiness of an image to be recorded was significantly decreased because the carbonate-based solvent was not contained in the non-aqueous ink composition of Comparative Example 1. It was shown that the glossiness of an image to be recorded was significantly decreased because the content of the carbonate-based solvent was less than 10% by mass in the non-aqueous ink composition of Comparative Example 2. In addition, in the non-aqueous ink compositions of Comparative Examples 1 and 2, the wet spreadability of an ink was not excellent so that an image in which stripe unevenness was generated or a line was disconnected was recorded.

In the non-aqueous ink compositions of Comparative Examples 3 and 4, it was shown that the glossiness of an image to be recorded was decreased because the carbonate-based solvent whose content was more than 40% by mass was contained therein. Further, it was confirmed that the printing unevenness was significantly generated in the non-aqueous ink compositions of Comparative Examples 3 and 4. For this reason, it is considered that the balance between the permeability and the wet spreadability of the non-aqueous ink composition was lost because of an increase in the content of the carbonate-based solvent.

Since the non-aqueous ink composition according to Comparative Example 4 did not contain the glycol ether-based solvent, but did contain 1,4-dioxane, an image to be recorded had an odor.

The invention is not limited to the above-described embodiments and various modifications are possible. For example, the invention has a configuration (for example, a configuration whose function, method, and result is the same or a configuration whose purpose and effect is the same) which is substantially the same as the configuration described in the embodiments. Further, the invention has a configuration in which a part, which is not substantive, of the configuration described in the embodiments is replaced. Further, the invention has a configuration whose action and effect are the same as those of the configuration described in the embodiments or a configuration capable of achieving the same purpose as that of the configuration described in the embodiments. Furthermore, the invention has a configuration which is the configuration described in the embodiments to which a known technique is added.

The entire disclosure of Japanese Patent Application No.: 2014-040642, filed Mar. 3, 2014 is expressly incorporated by reference herein.

What is claimed is:

1. A non-aqueous ink jet ink composition containing:
a coloring material;
a glycol ether-based solvent; and
10% by mass to 40% by mass of a carbonate-based solvent.

2. The non-aqueous ink jet ink composition according to claim 1, wherein the carbonate-based solvent is a compound represented by the general formula (2), 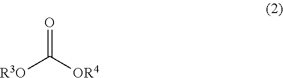
(in the general formula (2), R³ and R⁴ each independently represent a hydrocarbon group which may be substituted and has 1 to 4 carbon atoms).

3. The non-aqueous ink jet ink composition according to claim 1, wherein the carbonate-based solvent is at least one kind selected from dimethyl carbonate, ethyl methyl carbonate, and diethyl carbonate.

4. The non-aqueous ink jet ink composition according to claim 1, wherein the viscosity of the carbonate-based solvent at 20° C. is in a range of 0.3 mPa·S to 5 mPa·s.

5. The non-aqueous ink jet ink composition according to claim 1, wherein the content of the glycol ether-based solvent is in a range of 20% by mass to 80% by mass.

6. The non-aqueous ink jet ink composition according to claim 1, further containing at least one of a resin and a surfactant.

7. The non-aqueous ink jet ink composition according to claim 6, wherein the resin includes at least one of a polyester resin, a (meth)acrylic resin, and a vinyl chloride resin.

8. The non-aqueous ink jet ink composition according to claim 1, wherein the viscosity of the non-aqueous ink composition at 20° C. is in a range of 2 mPa·s to 15 mPa·s.

9. The non-aqueous ink jet ink composition according to claim 1, wherein the surface tension of the non-aqueous ink composition at 25° C. is in a range of 10 mN/m to 40 mN/m.

10. The non-aqueous ink jet ink composition according to claim 1, which is used for recording with respect to a recording medium having a recording surface that contains a vinyl chloride resin.

11. An ink jet recording method comprising:
ejecting droplets of the non-aqueous ink jet ink composition according to claim 1 from a recording head and adhering the droplets to a recording medium.

12. An ink jet recording method comprising:
ejecting droplets of the non-aqueous ink jet ink composition according to claim 2 from a recording head and adhering the droplets to a recording medium.

13. An ink jet recording method comprising:
ejecting droplets of the non-aqueous ink jet ink composition according to claim 3 from a recording head and adhering the droplets to a recording medium.

14. An ink jet recording method comprising:
ejecting droplets of the non-aqueous ink jet ink composition according to claim 4 from a recording head and adhering the droplets to a recording medium.

15. An ink jet recording method comprising:
ejecting droplets of the non-aqueous ink jet ink composition according to claim 5 from a recording head and adhering the droplets to a recording medium.

16. An ink jet recording method comprising:
ejecting droplets of the non-aqueous ink jet ink composition according to claim 6 from a recording head and adhering the droplets to a recording medium.

17. An ink jet recording method comprising:
ejecting droplets of the non-aqueous ink jet ink composition according to claim 7 from a recording head and adhering the droplets to a recording medium.

18. An ink jet recording method comprising:
ejecting droplets of the non-aqueous ink jet ink composition according to claim 8 from a recording head and adhering the droplets to a recording medium.

19. An ink jet recording method comprising:
ejecting droplets of the non-aqueous ink jet ink composition according to claim 9 from a recording head and adhering the droplets to a recording medium.

20. An ink jet recording method comprising:
ejecting droplets of the non-aqueous ink jet ink composition according to claim 10 from a recording head and adhering the droplets to a recording medium.
